(19) United States
(12) Patent Application Publication
(10) Pub. No.: US 2026/0084916 A1
(43) Pub. Date: Mar. 26, 2026

(54) SETTING TOOL AND METHOD FOR SETTING CONNECTING ELEMENTS AS WELL AS FOR CUTTING OFF A MATERIAL TAPE

(71) Applicant: Böllhoff Verbindungstechnik GmbH, Bielefeld (DE)

(72) Inventors: Bernd HAESLER, Halle (DE); Fabian AHLEMEYER, Gütersloh (DE); Kilian DOEDTMANN, Bramsche (DE); Benjamin RÖSCHERT, Schlangen (DE); Oliver SCHIENSTOCK, Delbrück (DE)

(21) Appl. No.: 19/215,734

(22) Filed: May 22, 2025

(30) Foreign Application Priority Data
May 24, 2024 (EP) 24177888.5

(51) Int. Cl. B65H 35/00

(52) U.S. Cl. CPC B65H 35/0086; B65H 2701/37

(57) ABSTRACT

A setting tool for setting connecting elements from a material tape. The setting tool comprises a C frame, a drive unit arranged at the C frame with a setting head that is linearly movable in the direction of a counter tool, an engine for displacing the material tape, arranged adjacent to the setting head and rigidly connected to the setting head, a cutting device for cutting the material tape, located behind the engine and comprising a cutting part with a blade and an actuating part, the cutting part being rigidly connected to the setting head, and the actuating part being connected to the setting tool such that there is a relative operational movement between the actuating part and cutting part, wherein the setting head is movable by the drive unit into a cutting position such that the blade cuts the material tape during actuation.

### 1. FIELD OF THE INVENTION

The present invention relates to a setting tool for setting connecting elements being provided by a material tape as well as a method for setting connecting elements being provided by a material tape as well as for cutting off the material tape.

### 2. BACKGROUND OF THE INVENTION

Setting tools for setting connecting elements are known in a large variety in the state of the art and are for example used in the sector of automotive manufacturing. Such setting tools are usually comprised of a C frame having a setting head and a counter tool attached.

The supply of the connecting elements to the setting head is for example carried out by means of belt or material tapes, with the connecting elements being correspondingly attached to the material tape or belt tape.

Such a system is, for example, described in WO 2018/189508 A1, together with different devices and methods for connecting rivet tapes. Moreover, a rivet joining clip is described here. It comprises an elongate body provided with a plurality of projections. The projections extend from one side of the elongate body and are provided with laterally projecting lips.

With these setting tools, the material tape is led from an output or supply device to the setting head. In the course of the setting method, the setting head separates the connecting element from the material tape so that at this location, the material tape is present without any connecting element. The material tape is now moved further and a new connecting element is arranged in the setting head so that above steps repeat.

Based on this general principle, it can be recognized that material tape without connecting element, that is empty material tape, accumulates in supply direction of the material tape behind the setting head. This material tape is normally cut off so that it is not present in the room in an undefined manner.

Known approaches include the manual separation by a worker, though devices based on pressurized air are also known which separate the material tape with a blade. However, particularly these latter systems are of disadvantage as an additional actuator and thus a corresponding control system is necessary.

An alternative system is known from EP 0 537 926 A1. Here, an assembly tool for detaching and applying components lined up continuously and attached to a belt or tape at an assembly position is described, in which one element after the other is successively separated from the tape and ejected. The tape is placed over an encircling continuous conveyor belt which positively engages the tape and entrains it with the advance of the conveyor belt. The conveyor belt together with the equipped tape passes through a driving-in region for gripping the tape prior to the assembly position and a driving-out region for carrying off the remaining tape after the assembly position. At the assembly position, the belt is deflected round the assembly position substantially in the form of a V. Moreover, a cutting device is provided at the assembly tool which is coupled to the pistons that are moving back and forth.

A disadvantage of this design is that the material tape is cut off after each setting stroke. An application specific separation is thus not intended. Furthermore, the separated pieces of the material tape arise at or close to the assembly position which is also disadvantageous. Finally, the cutting device is provided in the housing of the assembly tool, having a disadvantageous effect on the accessibility in terms of maintenance and repair work.

It is therefore the object of the present invention to optimize a known setting tool, which provides the connecting elements by means of a material tape, with respect to a cutting device for the material tape. It is also an object of the present invention to provide a corresponding method.

### 3. SUMMARY OF THE INVENTION

The above object is solved by a setting tool for setting connecting elements provided by a material tape according to the independent claim 1 and a method for setting connecting elements provided by a material tape as well as for cutting off the material tape according to the independent claim 8. Advantageous embodiments and further developments arise from the subsequent description, the drawings as well as the appending claims.

An inventive setting tool for setting connecting elements provided by a material tape comprises a C frame, a drive unit arranged at the C frame with a setting head with which the setting head is linearly movable in the direction of a counter tool that is arranged at the C frame opposite the setting head, so that a setting stroke between a setting position for setting the connecting element and a receiving position for receiving a subsequent connecting element from the material tape is defined, an engine, in particular a roller engine for displacing the material tape, with the engine being arranged adjacent to the setting head and being connected to the setting head in a way that it is rigidly arranged relative to the setting head, a cutting device for cutting off the material tape, which is located in supply direction of the material tape behind the engine and comprises a cutting part with a blade as well as an actuating part, with the cutting part being connected to the setting head, so that the cutting part is arranged rigidly relative to the setting head, and the actuating part is connected to the setting tool in a way that during operation of the setting tool, there is a relative movement between actuating part and cutting part, with the setting head being movable by the drive unit to a cutting position, which is spaced from the receiving position in a direction opposite to the setting position and in which the blade of the cutting part cuts the material tape due to an actuation by the actuating part transverse to the supply direction of the material tape.

For better comprehensibility, the inventive setting tool is explained based on its use. Here, the starting point is the setting tool having the setting head located in a receiving position, with a connecting element already being arranged in the setting head. Rivets or screws are for example possible as connecting elements.

For further increasing comprehensibility, the terms setting position and receiving position are first of all defined. The starting point is the linear movement of the setting head which is limited by two extreme positions, namely a completely extended position and a completely withdrawn or retracted position. With respect to the distance between setting head and counter tool that is arranged opposite the setting head, it is smallest in the completely extended position, while in the completely retracted position, the distance between setting head and counter tool is largest.

The setting position of the setting head is a position in which the connecting element can be set into a component or into the components to be connected. Thus, the setting head is located in or neighboring the completely extended position. It must be considered that the setting position depending on the respective application case can vary.

In the receiving position, the setting head is arranged in a displaced manner based on the setting position in the direction of the completely retracted position. Preferably, a new connecting element is arranged in this position in the setting head. The linear movement between the setting position and the receiving position defines a setting stroke of the setting tool. Instead of the term of the receiving position, this position could also be referred to as turning position.

As has already been indicated above, the setting stroke depends on the respective application. For instance, in case of a longer connecting element, the receiving or turning position is further away from the setting position than in case of a shorter connecting element. Furthermore, the setting stroke depends on the component(s) into which the connecting element(s) is intended to be set.

The material tape with the connecting elements is provided by an output device, e.g. a coil or a providing module, is guided through the setting head, after that, proceeds over the engine and from there, it arrives at the cutting device which in supply direction of the material tape is thus arranged behind the engine. Due to the connection of engine and cutting part of the cutting device with the setting head, they carry out the movement of the setting head. Therefore, engine and cutting part do not carry out any relative movement with respect to the setting head and are arranged rigidly with respect to the setting head.

For the sake of completeness it must be considered that the engine for displacing the material tape can displace the material at the same time with moving back the setting head in the direction of the receiving position or only when reaching the receiving position. Preferably, a connecting element is arranged in the setting head in the receiving position before another movement of the setting head in the direction of the setting position.

With respect to the starting condition, the course of procedure with the inventive setting tool is explained. The setting head with the connecting element of the material tape arranged in it is linearly moved by the drive unit from the receiving position into the setting position.

Thus, a setting force or torque is provided by the drive unit in order to move the setting head linearly towards the counter tool or away from it.

In the setting position, the setting of the connecting element takes place. Subsequently, the setting head is moved back from the setting position into the receiving position. During or after displacing the setting head from the setting position into the receiving position, the engine is activated in order to displace the material tape. A further or new connecting element is arranged in the setting head by that so that it is present in the receiving position of the setting head.

Now, the setting of the new connecting element takes place analogously.

After performing these steps multiple times, emptied material tape, i.e. material tape without connecting elements, is present in supply direction of the material tape behind the engine and thus behind the cutting device.

For cutting off this material tape, the setting head is moved from the drive unit into the cutting position. The cutting position is next to or at the completely retracted position of the setting head. Thus, the cutting position is spaced apart from the receiving position in a direction opposite to the setting position. With regard to the setting position, the cutting position is therefore further away from the setting position than the receiving position.

The movement of the setting head into the cutting position causes the cutting part, that is rigidly connected to the setting head, of the cutting device to come into engagement with the actuating part of the cutting device. For this purpose, the actuating part is connected to the setting tool in a way that during operation of the setting tool, there is a relative movement between the actuating part and the cutting part. For this purpose, the actuating part may be fastened to the housing of the setting head, the housing being rigidly connected with the C frame, to the C frame or to another location which does not carry out any movement that is determined by the setting head.

Due to the engagement of the cutting part with the actuating part, the blade is moved in the direction of the material tape and cuts the material tape transverse to the supply direction. For this purpose, the cutting device preferably comprises a counter holder apart from the blade. That way, no tension in or rigidness of the material tape is necessary, in contrast to systems with blade, only.

The inventive setting tool therefore uses a mechanic for the double use of the drive unit, as it does not only move the setting head but is also used for actuating the separation of the material tape. Therefore, further actuator technology becomes superfluous as the present movement energy of the setting head is used. It is particularly this arrangement of the actuating part relative to the cutting part which makes the setting tool particularly efficient. This will become even clearer in consideration of the preferred embodiments.

When approaching the cutting position, the maximum stroke that is possible by the setting head is for example taken advantage of. As it is greater than the setting stroke, positions out of the setting stroke for actuating further mechanisms can be used.

Furthermore, another advantage of this setting tool is that the material tape may be separated specifically for the respective application case, e.g. at desired times, after a desired number of setting processes and/or on a manual command. Thus, the effectiveness of the setting tool is further increased, as the processing time is particularly reduced. For example, the setting processes do not have to be interrupted for separating the material tape and no interruption due to manually cutting off the material tape is necessary.

Finally, it is advantageous that the material tape does not have to be threaded anew into the cutting device after having been cut or separated, as the relative position between cutting part of the cutting device and setting head does not change due to the rigid connection and the moving of the cutting part with the setting head.

In a preferred embodiment of the setting tool, the setting tool furthermore comprises a control with which the cutting position remote from the receiving position can specifically be controlled or reached by means of the drive unit. With regard to the setting tool that is equipped with the control, it is particularly advantageous that the control comprises: a position detection, with which a position of the setting head can be detected for specifically controlling or reaching of the cutting position, a counter wherein the cutting position may be controlled or reached depending on the counter, and/or a storage for saving the programming of the setting tool, a counter reading regarding the number of setting processes and/or position data of the setting head.

The use of a control serves for controlling the drive unit of the setting tool. The advantageous combination with a position detection in particular allows the control of the setting tool depending on the precise position of the setting head. This improves the effectiveness of the procedure and the device further. Furthermore, due to the control, the separation of the material tape can be linked to specific rules, independent of the setting process. Thus, the number of set connecting elements can be determined so as to cut off the material tape when reaching a defined maximum value. This cutting off function can also be triggered individually, e.g. acyclically, depending on the work process and/or counter reading and/or operating time. For this purpose, preferably the storage for saving the programming and/or counter reading and positions of the setting tool or the setting head, respectively, is provided.

In a further preferred embodiment of the setting tool, the actuating part comprises a cam and the cutting part comprises a projection, in particular in the form of a roller, so that in case of a movement of the projection over the cam, the blade is moved in the direction of the material tape and the material tape is cut off. The combination of projection and cam makes further actuator technology superfluous and provides a particularly robust mechanical system for separating the material tape. This system is particularly robust with regard to environmental influences compared to systems having their own actuator technology and/or detection of sensor data.

In the design with cams and projection, it is particularly advantageous that the cutting part comprises a plate with the blade, with the plate having a rotation axis at one end and is connected to the roller at the other end so that the material tape can be cut by means of a pivoting movement of the blade. Due to the pivotable arrangement of the blade, the leverage effect is taken advantage of. In addition, when using such a blade, a counter holder is also preferred so that no tension or stiffness of the material tape is necessary, in contrast to cutting off systems with a blade, only.

Alternatively to the blade that is arranged pivotably, a blade that is arranged in a rotating manner is also preferred, as by that, the separating of the material tape can be realized particularly efficiently, too. For realizing this design, it is preferred that the projection that is formed like a roller is configured as a roller with teeth, with the teeth being provided over a partial circumference of the roller. Instead of the cam at the actuating part, a tooth rail is provided which matches the teeth of the roller. The blade which is provided at another circumferential position of the roller that is equipped with teeth will therefore carry out a rotating movement when engaging the tooth rail that is provided at the actuating part.

According to a preferred embodiment of the setting tool, the actuating part can be moved independently of the setting head, preferably perpendicular to the direction of movement of the setting head so that an interaction between the actuating part and the cutting part in the cutting position is avoided. With this preferred configuration, the actuating part can be moved between a rest position and an engaging position. In the rest position, the actuating part is not located in the path of motion of the cutting part while when in the engaging position, it is arranged in the path of motion. In other words, in the rest position, the actuating part is arranged at such a distance to the cutting part that for example cams or projections or teeth and tooth rail cannot come into engagement.

Particularly this configuration allows the drive unit to move the setting head in the completely retracted position in case of major interfering contours without the material tape being cut. In addition, the cutting position can also be varied due to the movability of the actuating part and be adapted to the respective application case. Overall, the application field of the setting tool is further increased.

In a further preferred embodiment of the setting tool, the setting tool comprises a guide for the cutting part which is comprised of a rail that is fastened to the cutting part as well as a counter rail that is connected to the C frame. Particularly the use of a rail system as the guide leads to a stiffening of the cutting device against a bending away, in particular with regard to the cutting part as well as the engine, which is preferably also arranged at this guide, as particularly by that, a defined distance between the engine and the cutting device is given and does not need to be considered additionally. This will further facilitate the application of the setting tool.

An inventive method for setting connecting elements provided with a material tape as well as for cutting off the material tape, in particular by using the inventive setting tool, comprises the steps: moving a setting head with a connecting element of the material tape arranged in it from a receiving position to a setting position, setting the connecting element in the setting position, moving back the setting head from the setting position to the receiving position, actuating an engine, in particular a roller engine, for displacing the material tape, the engine being located next to the setting head and being connected to the setting head so that it is rigidly arranged relative to the setting head, causing a subsequent connecting element to be arranged in the setting head in the receiving position of the setting head, and moving the setting head with the drive unit to a cutting position which is at a distance to the receiving position in a contrary direction to the setting position, with a cutting device that is arranged in supply direction of the material tape behind the engine cutting off the material tape transverse to the supply direction of the material tape in the cutting position, with the cutting device comprising a cutting part with a blade and an actuating part, the cutting part being connected to the setting head so that the cutting part is rigidly arranged relative to the setting head, and the actuating part is connected to the setting tool in a way that when the setting tool operates, there is a relative movement between actuating part and cutting part and in the cutting position, the blade cuts the material tape transverse to the supply direction of the material tape due to an actuation by the actuating part. Thus, with the inventive method, a connecting element which is provided with a material tape is set and the material tape is cut off application-specifically. Therefore, this approach can be implemented particularly effectively in combination with the inventive setting tool so that corresponding reference is made to the above statements. Alternatively, the method can be applied to each setting tool not requiring the maximum way of the setting head with every setting stroke.

In a preferred embodiment of the setting method, the setting head is moved into the cutting position due to: a number of setting strokes between setting position and receiving position, with the cutting off taking place after two, preferably three and particularly preferred five setting strokes, the operating time of the setting tool and/or a manually actuated cutting command. The method applied to a setting tool therefore allows a control of the setting tool that is optimized for the specific application case.

In a further preferred embodiment of the setting method, the setting method includes the further step before or at the same time of moving the setting head into the cutting position: moving the setting tool to a collecting container for cut-off material tape. That way, the empty material tape can be collected at one place, which will reduce the processing time.

Finally, it is preferred that the setting method comprises the further step: moving the actuating part of the cutting device in a direction perpendicular to the moving direction of the setting head from an engaging position and into a rest position, wherein in the rest position, an interaction between actuating part and cutting part in the cutting position is prevented. That way, a corresponding setting tool can also reach the cutting position with the setting head, without a cutting off process being carried out. This is particularly advantageous when the setting head is supposed to be moved into the completely retracted or withdrawn position, though without cutting off the material tape. Alternatively to the movement perpendicular to the moving direction of the setting head, a variable adjustment can also be made with a movement of the actuating part parallel to the moving direction of the setting head. Therefore, this configuration is particularly preferred, too.

### 4. SHORT DESCRIPTION OF THE DRAWINGS

In the following, the present invention is described in detail with reference to the drawings. In this context, the same reference signs refer to the same components and/or elements. They show:

FIG. 1 a lateral view of an embodiment of an inventive setting tool in connection with a robot,

FIG. 2 a sectional view of the embodiment of the setting tool according to FIG. 1,

FIG. 3 a sectional view of a first configuration of the cutting device,

FIG. 4 a sectional view of a second configuration of the cutting device,

FIG. 5 a sectional view of an embodiment of the inventive setting tool in the receiving position,

FIG. 6 an enlarged view of a section of the cutting device in the position according to FIG. 5,

FIG. 7 a sectional view of an embodiment of the inventive setting tool in the setting position,

FIG. 8 an enlarged view of a section of the cutting device in the position according to FIG. 7,

FIG. 9 a sectional view of an embodiment of the inventive setting tool in the cutting position,

FIG. 10 an enlarged view of a section of the cutting device in the position according to FIG. 9,

FIG. 11 a lateral view of an embodiment of the cutting device,

FIG. 12 a sectional view of the cutting device in the receiving position of the setting tool,

FIG. 13 a sectional view of the cutting device in the cutting position of the setting tool,

FIG. 14 a first sectional view of the cutting device for illustrating the relative movement between cutting part and actuating part,

FIG. 15 a second sectional view of the cutting device for illustrating the relative movement between cutting part and actuating part,

FIG. 16 a third sectional view of the cutting device for illustrating the relative movement between cutting part and actuating part,

FIG. 17 a flow chart for schematically illustrating an embodiment of an inventive method.

### 5. DETAILED DESCRIPTION OF THE PREFERRED EMBODIMENTS

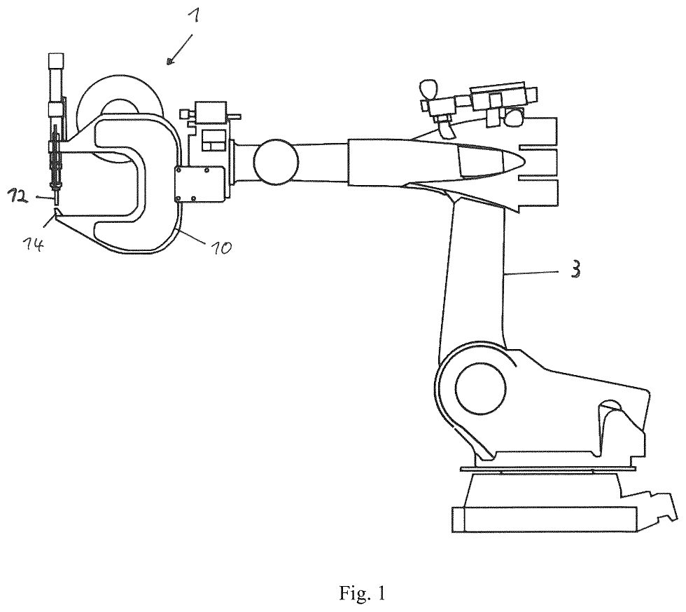

Firstly, with respect to FIG. 1, a setting tool 1 in combination with a robot 3 is shown. In the known manner, the setting tool 1 comprises a C frame 10 to which a drive unit with setting head 12 and a counter tool 14 is arranged.

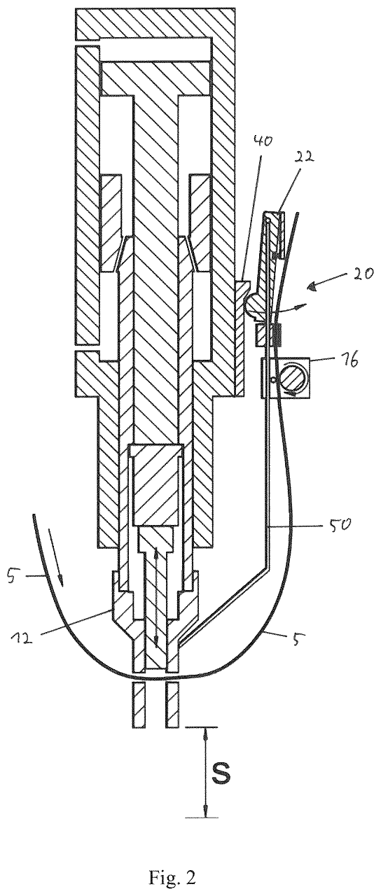

With respect to FIG. 2, the assembly of the setting tool 1 is now described by specifically considering the setting head 12. The connecting elements to be set by the setting tool 1 are supplied to the setting head 12 by means of a material tape 5. Rivets or screws are for example possible as connecting elements.

The material tape 5 with the connecting elements is provided by an output device, e.g. a coil or a providing module, is guided through the setting head 12, after that, proceeds over an engine 16 and from there, it arrives at a cutting device 20 which is thus arranged in supply direction of the material tape 5 behind the engine 16.

The engine 16, in particular a roller engine, is provided for displacing the material tape 5. As can be recognized in FIG. 2, the engine 16 is arranged adjoining the setting head 12 and is connected to the setting head 12 in a way that it is arranged rigidly with regard to the setting head 12. In the illustrated example, this takes place by means of a guide 50 which consists of a rail and a counter rail, which will also be clarified later.

Finally, the setting tool 1 comprises a cutting device 20 for cutting off the material tape 5. In supply direction of the material tape 5, the cutting device 20 is located behind the engine 16 and comprises a cutting part 22 with a blade 24 as well as an actuating part 40.

The cutting part 22 is connected to the setting head 12 so that the cutting part 22 is arranged rigidly with respect to the setting head 12. In the illustrated embodiment, this is realized by means of the guide 50, which consists of a rail and a counter rail. The rail is for example fastened at the cutting part 22 and thus at the engine 16, too, while the counter rail is for example connected to the C frame 10, the housing of the setting head 12 or another unit which is not moved with or by the setting head.

Particularly the use of a rail system as guide 50 leads to a stiffening of the cutting device 20 against bending away, in particular with regard to the cutting part 22 as well as the engine 16. Another advantage of such a guide 50 is that a defined distance between the engine 16 and the cutting device 20 is given and therefore, no change of the distance must be taken into consideration.

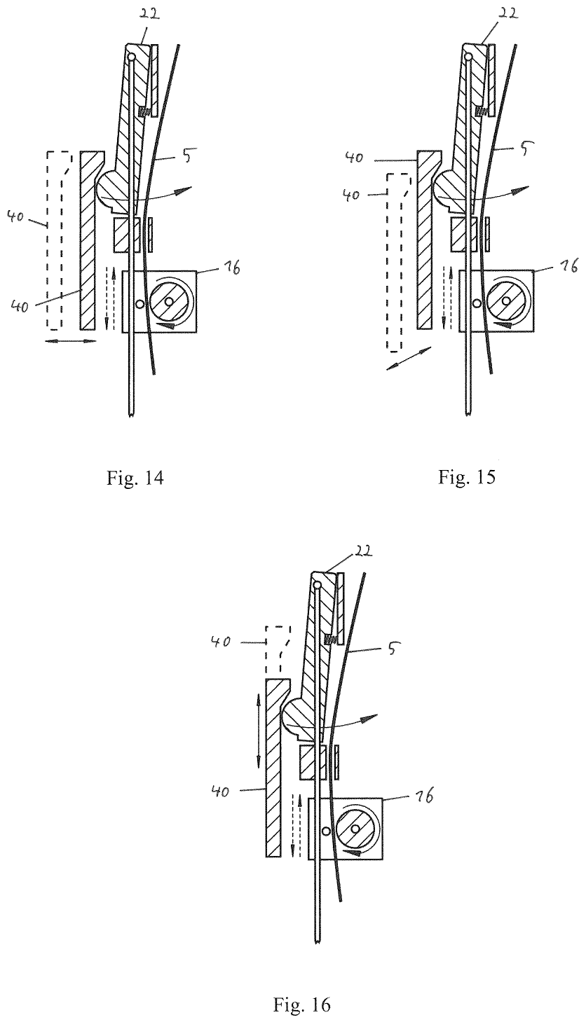

The actuating part 40 is therefore connected to the setting tool 1 in a way that during operation of the setting tool 1, there is a relative movement between actuating part 40 and cutting part 22. This can be realized by means of a fastening to the housing of the setting head 12, to the C frame 10 or another location which in case of a movement of the setting head 12 is not moved by the setting head 12. The fastening of the actuating part 40 can be a fixed or a moveable fastening, as long as a relative movement between actuating part 40 and cutting part 22 can be realized. This will also be explained later, in particular with respect to FIGS. 14 to 16.

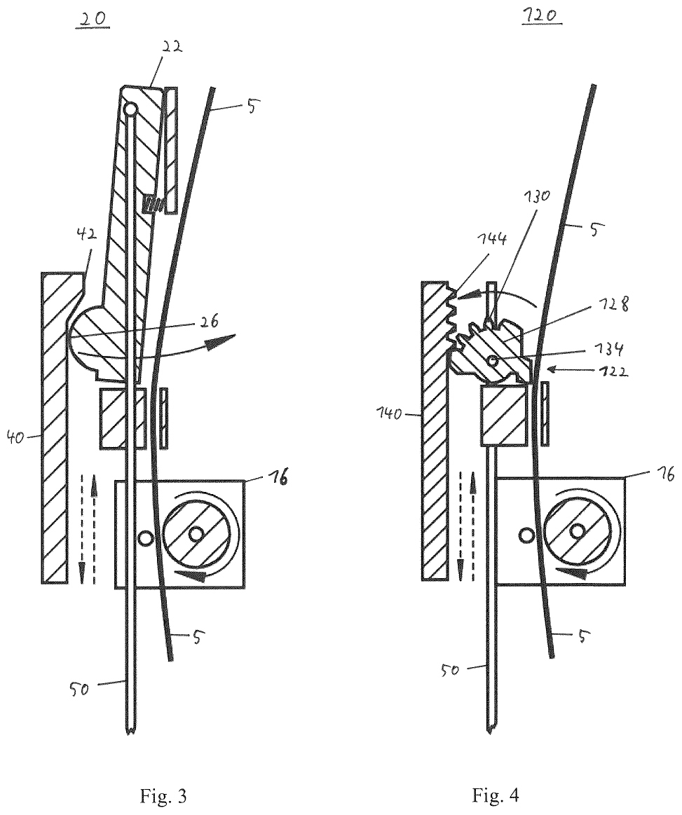

Before the functionality of the setting tool 1 is now explained on the basis of the operation, different embodiments of the cutting device 20 are discussed based on the FIGS. 3 and 4.

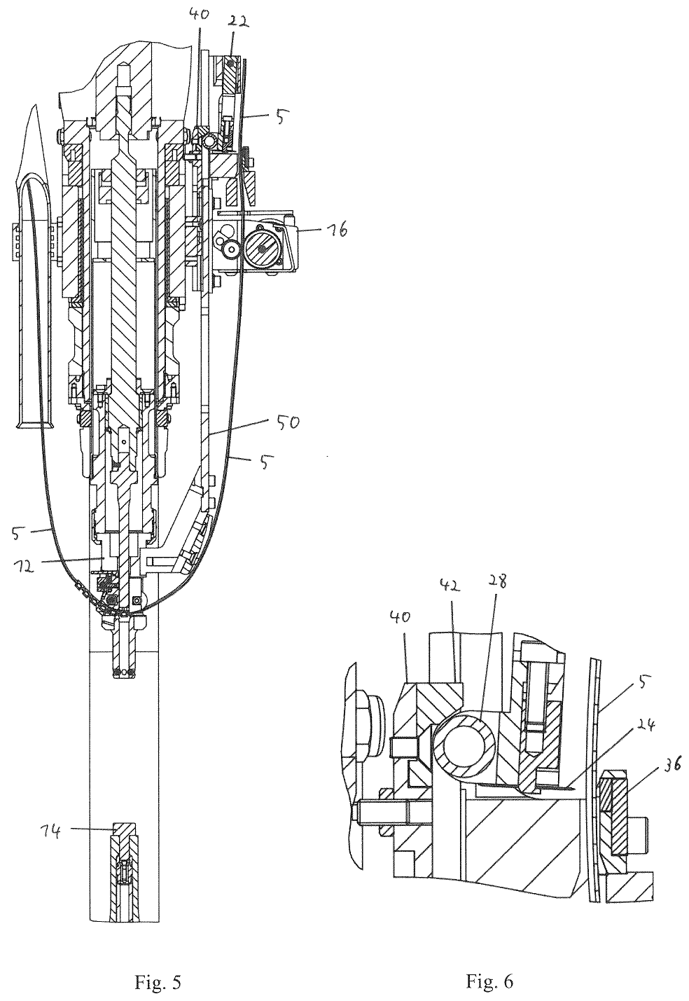

In the embodiment according to FIG. 3, an enlarged view of the cutting device 20 of FIG. 2 is shown. In this configuration, the actuating part 40 comprises a cam 42. The cutting part 22 comprises a plate 32 with the blade 24 as well as a projection 26. At one end, the plate 32 comprises a rotation axis 34 and at the other end, it is connected to the projection 26. Advantageously, the projection 26 consists of a roller 28, which will be explained later with respect to FIGS. 5 to 13 and in particular FIGS. 11 to 13.

As soon as the projection 26 is moved in the direction of the arrow to the top and comes into engagement with the cam 42, the plate 32 and thus the blade 24 is pivoted around the rotation axis 34 and the material tape 5 is separated or cut.

In order to facilitate this approach, a counter holder 36 is provided opposite the blade 24. Therefore, no tension or stiffness of the material tape 5 is necessary, in contrast to cutting off systems with blade 24, only.

In the alternative embodiment of the cutting device 120, the cutting part 122 comprises a roller 128 that is equipped with teeth 130. The teeth 130 are provided over a partial circumference of the roller 128. The actuating part 140 comprises a portion with a tooth rail 144. This leads to the same functionality as discussed above, because as soon as the teeth 130 of the roller 128 engage with the tooth rail 144, the roller 128 is rotated around the rotation axis 134 causing the material tape 5 to be separated.

Both configurations of the cutting device 20 therefore make use of a lever effect. In addition, due to the combination of projection 26 and cam 42 or teeth 130 and tooth rail 144, respectively, a further actuator technology becomes obsolete and provides a particularly robust mechanical system for separating the material tape 5. This system is particularly robust towards environmental impacts in comparison to systems having their own actuator technology and/or detection of sensor data.

Due to the drive unit, the setting head 12 is linearly movable in the direction toward and away from the counter tool 14. This linear movement of the setting head 12 is limited by two extreme positions, namely a completely extended position and a completely retracted or withdrawn position. With regard to the distance between setting head 12 and the counter tool 14 that is arranged opposite the setting head 12, it is thus smallest in case of the completely extended position of the setting head 12, while the distance between setting head 12 and counter tool 14 in the completely retracted position of the setting head 12 is largest.

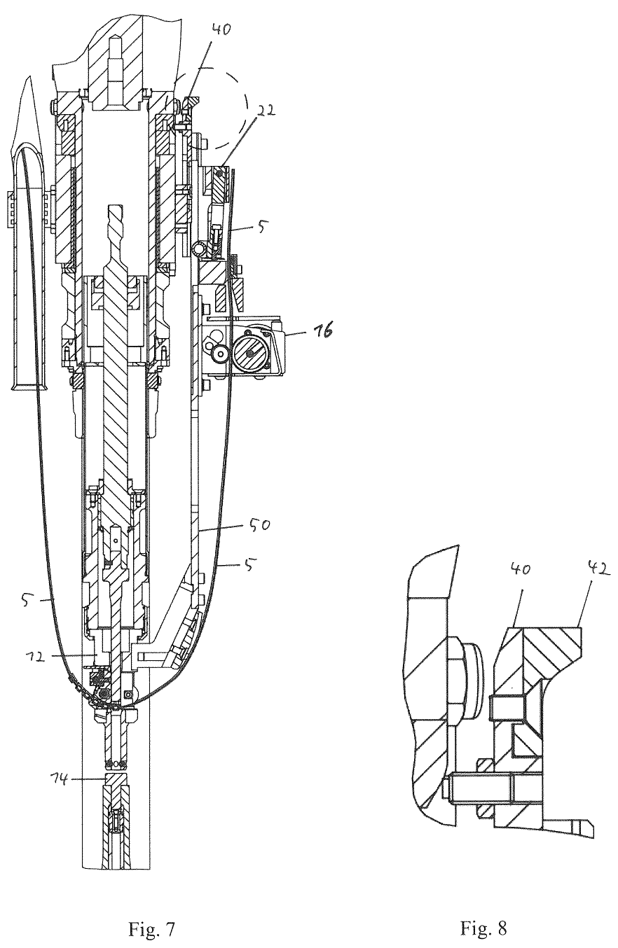

The setting position of the setting head 12 is a position in which the connecting element can be set into a component or into the components to be connected. Therefore, the setting head 12 is located in or adjoining the completely extended position. It must be noted that the setting position can vary depending on the respective application case. In this context, exemplary reference is made to the illustration in FIGS. 7 and 8 which show the setting head 12 and the cutting device 20, respectively, in the setting position.

In the receiving position, the setting head 12 is arranged in a displaced manner based on the setting position in the direction of the completely retracted position. The linear movement between the setting position and the receiving position defines a setting stroke S of the setting tool 1, as indicated in FIG. 2. Alternatively, the receiving position can therefore also be referred to as turning position, as at this location, a change of the direction of the movement of the setting head 12 takes place while the setting stroke S is performed. In the receiving or turning position, a new connecting element is preferably arranged in the setting head 12, for illustration purposes, reference is made to FIGS. 5 and 6 in this regard, which show the setting head 12 and the cutting device 20, respectively, in the receiving or turning position.

The setting stroke S depends on the respective application. Thus, in case of a longer connecting element, the receiving position is further away from the setting position than in case of a short connecting element. In addition, the setting stroke S depends on the component or components into which the connecting element is intended to be set.

Due to the connection of engine 16 and cutting part 22 of the cutting device 20 with the setting head 12 due to the guide 50, same recreate the movement of the setting head 12. Therefore, engine 16 and cutting part 22 do not show any relative movement with respect to each other and with respect to the setting head 12 and are arranged rigidly with respect to the setting head 12.

The functionality of the setting tool 1 is now explained with respect to FIGS. 5 to 10.

FIG. 5 shows the setting tool 1 in the receiving position, and FIG. 6 shows an enlarged view of the actuating part 40 of FIG. 5.

Based on this receiving position, the setting head 12 with the connecting element of the material tape 5 that is arranged in it is first of all linearly moved by the drive unit into the setting position. Therefore, a setting force or torque is provided with the drive unit so as to linearly move the setting head 12 in the direction of the counter tool 14 and away from it.

In the setting position that is shown in FIG. 7 for the setting tool 1 and in FIG. 8 for the actuating part 40 of the cutting device 20, the setting of the connecting element takes place. As the cutting part 22 is moved along with the setting head 12, the cutting part 22 is located remote from the actuating part 40.

After the setting, the setting head 12 is moved back from the setting position into the receiving position. During or after moving the setting head 12 from the setting position into the receiving position, the engine 16 is actuated for displacing the material tape 5. As a result, a further or new connecting element is arranged in the setting head 12, so that same is present in the receiving or turning position. Now, the setting of the new connecting element takes place analogously.

Once these steps have been carried out multiple times, there is an empty material tape 5, i.e. a material tape 5 without connecting elements, in supply direction of the material tape 5 behind the engine 16 and thus also behind the cutting device 20.

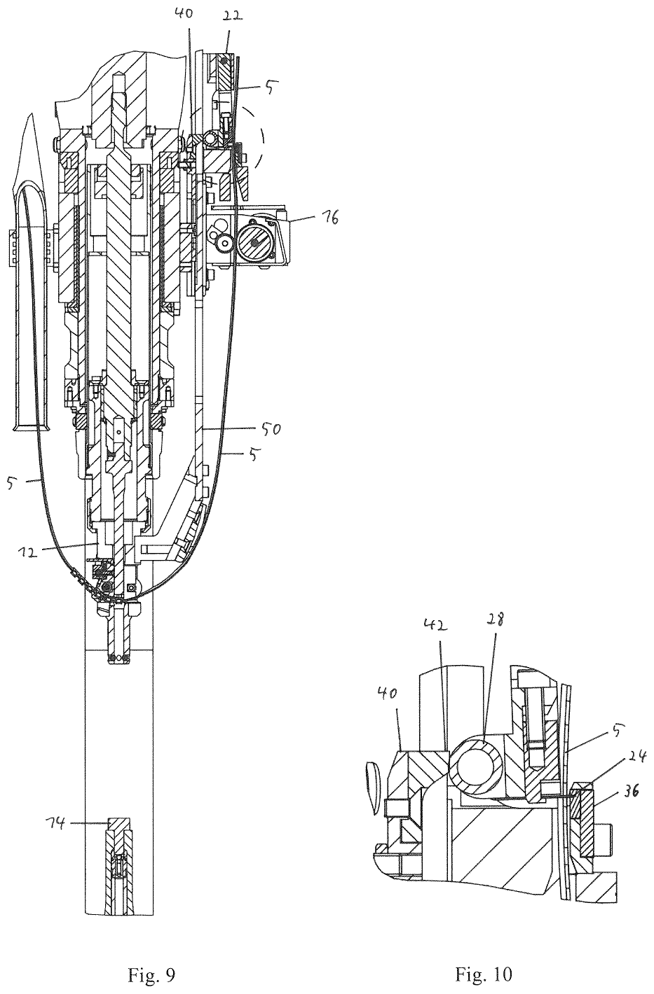

To cut this material tape 5, the setting head 12 is moved from the drive unit to the cutting position. This is shown in FIG. 9 for the setting tool 1 and in FIG. 10 for the cutting device 20.

The cutting position is located adjacent to or at the completely retracted position of the setting head 12. Therefore, the cutting position is located with a distance from the receiving position in a direction opposite the setting position. With regard to the setting position, the cutting position is therefore further away from the setting position than the receiving position.

The movement of the setting head 12 into the cutting position causes the cutting part 22, that is connected to the setting head 12, of the cutting device 20 to come into engagement with the actuating part 40 of the cutting device 20, as explained above.

Due to the engagement of the cutting part 22 with the actuating part 40, the blade 24 is moved in the direction of the material tape 5 and cuts the material tape 5 transverse with respect to the supply direction.

The setting tool 1 therefore uses a mechanic for the double use of the drive unit, because now, it does not only move the setting head 12 but is also used for activating the separating of the material tape 5. Thus, further actuator technology becomes unnecessary as the available movement energy of the setting head 12 is used. Particularly due to the arrangement of the actuating part 40 relative to the cutting part 22, the setting tool 1 is particularly efficient.

When approaching the cutting position, the maximum stroke possible by the setting head 12 can for example be taken advantage of. As it is greater than the setting stroke S, positions outside the setting stroke S can be used for actuating further mechanisms.

Furthermore, a further advantage of this setting tool 1 is that the material tape 5 can be separated specifically for the respective application case, e.g. at desired times, after a desired number of setting operations and/or due to a manual command. By that, the effectiveness of the setting tool 1 is further increased, as particularly the processing time is reduced. For example, setting operations do not have to be interrupted for separating the material tape 5 and no interruption due to manually cutting off the material tape 5 is necessary, either.

Finally, it is advantageous that the material tape 5 does not need to be threaded anew into the cutting device 20 after being cut off or separated as the relative position between cutting part 22 of the cutting device 20 and setting head 12 does not change due to the rigid connection and the moving of the cutting part 22 with the setting head 12.

In order to make the most of the setting tool 1, a control is preferably provided with which by means of the drive unit, the cutting position can be specifically controlled or reached remote from the receiving position. With regard to the setting tool 1 that is equipped with the control, it is particularly advantageous that the control comprises: a position detection with which a position of the setting head 12 can be detected in order to specifically control or reach the cutting position, a counter, with the cutting position being controllable or reachable depending on the counter, and/or a storage for storing the programming of the setting tool 1, a counter reading regarding the number of setting processes and/or positioning data of the setting head 12.

The use of a control preferably serves for controlling the drive unit of the setting tool 1. It is particularly the advantageous combination with a position detection that allows the control of the setting tool 1 depending on the precise position of the setting head 12. This improves the effectiveness of the method and device further.

Additionally, due to the control, the separation of the material tape 5 can be linked to certain rules, independent of the setting operation. Thus, the number of set connecting elements can be detected in order to be able to cut or separate the material tape 5 when reaching a defined maximum value. The cutting off function can be activated individually, for example acyclically, depending on the working process and/or counter reading and/or operating time. For this purpose, the storage for storing the programming/rules and/or counter readings and positions of the setting tool 1 or the setting head 12, respectively, is provided.

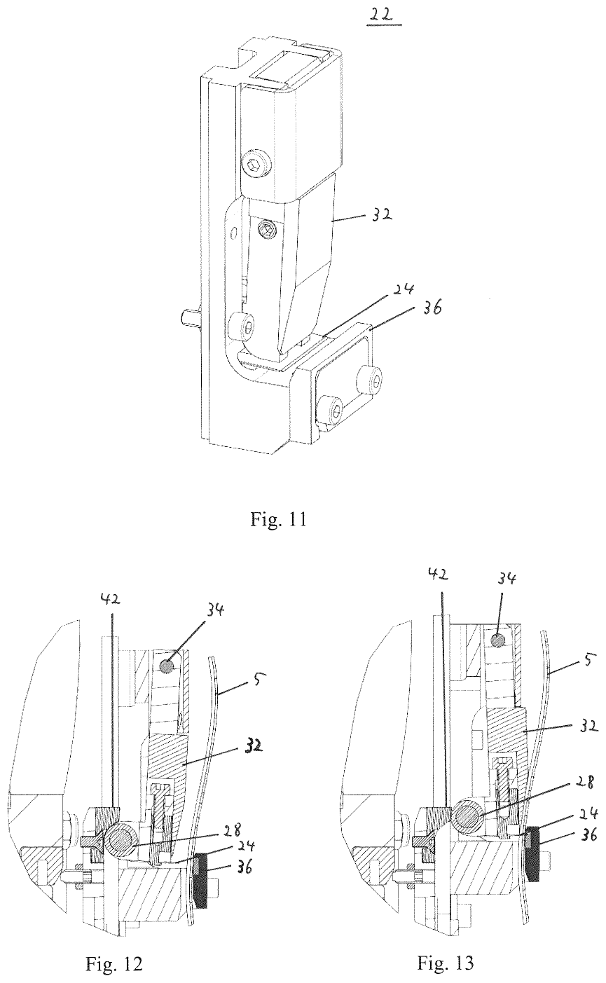

For clarification, FIGS. 11 to 13 show different views of the cutting device 20. While FIG. 11 provides a perspective view of the cutting device 20, FIG. 12 shows a sectional view in the receiving position and FIG. 13 shows a sectional view in the cutting position of the setting head 12. In this configuration, a roller 18 is used as the projection 26 at the cutting part 22. This supports the movement of the cutting part 22 relative to the actuating part 40.

With reference to FIGS. 14 to 16, particularly preferred variants of the cutting device 20 are discussed. These devices have in common that the actuating part 40 is also movably arranged, it is, however, not coupled to the movement of the setting head 12. Consequently, the flexibility of the setting tool 1 is further increased.

As for example shown in FIG. 14, the actuating part 40 is movable perpendicular to the moving direction of the setting head 12. As a result, an interaction between actuating part 40 and cutting part 22 in the cutting position can be prevented. In other words, the actuating part 40 can be moved between a rest position and an engaging position. In the rest position, the actuating part 40 is not located in the moving rail of the cutting part 22, while when in the engaging position, it is arranged in the moving rail.

Consequently, it is possible that particularly in case of greater interfering contours of the components to be connected to one another, the drive unit cannot move the setting head 12 to the completely retracted position without the material tape 5 being cut. This increases the application field of the setting tool 12 further.

Beside moving the actuating part 40 perpendicular to the moving direction of the setting head 12, a diagonal movement can also be realized. In this regard, reference is made to FIG. 15.

Finally and according to the possibility shown in FIG. 16, the actuating part 40 may also be arranged parallel to the moving direction of the setting head 12 in a movable manner at the setting tool 1. Through this, the cutting position can advantageously be adapted to the respective application.

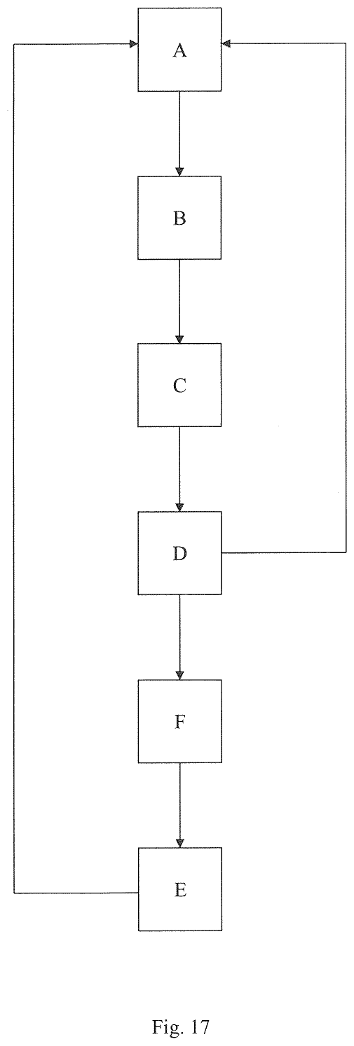

With reference to FIG. 17, a schematic course of procedure of a method for setting connecting elements that are provided by a material tape 5 as well as for cutting off the material tape 5 is explained. In a first step A, a setting head 12 with a connecting element of the material tape 5 arranged in it is moved from a receiving position to a setting position. After that, a setting of the connecting element in the setting position takes place in step B.

After the setting, the setting head 12 is moved back from the setting position into the receiving position (step C) and the engine 16 for displacing the material tape 5 is actuated (step D). For doing so, the engine 16 is arranged adjacent to the setting head 12 and is connected to the setting head 12 in a way that it is arranged rigidly relative to the setting head 12. By that, a subsequent connecting element is or will be arranged in the setting head 12 in the receiving or turning position of the setting head 12.

These steps are now repeated so that there is empty material tape 5 behind the engine 16 and thus also behind the cutting device 20, 120. In a first step, this material tape 5 can be collected so that it is not cut or does not need to be cut after each setting process.

It is only in step E that ultimately, a moving of the setting head 12 with the drive unit into a cutting position takes place which is located with a distance to the receiving position in a direction opposite to the setting position. This takes place depending on a number of setting strokes S between setting position and receiving position, with the cutting off taking place after two, preferably three and particularly preferred five setting strokes S, the operating time of the setting tool 1, and/or the setting head 12 is moved to a cutting position by means of a manually actuated cutting command.

In the cutting position, a cutting device 20, 120 that is arranged in supply direction of the material tape 5 behind the engine 16 cuts the material tape 5 transverse to the supply direction of the material tape 5. For this purpose, the cutting device 20, 120 comprises a cutting part 22, 122 with a blade 24 and an actuating part 40, 140. The cutting part 22, 122 is connected to the setting head 12 so that the cutting part 22, 122 is arranged relative to the setting head 12 in a rigid way. The actuating part 40, 140 is therefore connected to the setting tool 1 in a way that when the setting tool 1 operates, there is a relative movement between actuating part 40, 140 and cutting part 22, 122. In the cutting position, the blade 24 cuts the material tape 5 transverse to the supply direction of the material tape 5 due to an actuation by the actuating part 40, 140.

Advantageously, the setting tool 1 is moved to a collecting container for cut-off material tape 5 in step F. This can take place before or at the same time of moving the setting head 12 to the cutting position. That way, the empty material tape 5 can be collected at one location which reduces the processing time.

With the method, a connecting element that is provided by the material tape 5 is therefore set and the material tape 5 is cut off in an application-specific way. This approach may therefore be implemented particularly effectively in combination with an embodiment of the inventive setting tool 1, as described above. Therefore, respective reference is made to the above explanations. Alternatively, the method is applicable to every setting tool 1 which in the setting operation does not require the maximum way of the setting head 12 with every setting stroke S.

It is particularly preferred that the actuating part 40, 140 of the cutting device 20, 120 is moved in a direction perpendicular to the moving direction of the setting head 12 from an engaging position to a rest position. In the rest position, an interaction between actuating part 40, 140 and cutting part 20, 120 in the cutting position is prevented. Accordingly, the actuating part 40, 140 and the cutting part 20, 120 of the cutting device can only come into engagement when the actuating part is in the engaging position. That way, a respective setting tool 1 can also approach the cutting position with the setting head 12, without carrying out a cutting off process. This is particularly advantageous when the setting head 12 is intended to be moved in the completely retracted or withdrawn position, though without cutting off the material tape 5. Alternatively to the movement perpendicular to the moving direction of the setting head 12, a variable setting may also be realized by means of a movement of the actuating part 40, 140 parallel to the moving direction of the setting head 12, as discussed above.

### 6. LIST OF REFERENCE SIGNS

1 setting tool
3 robot
5 material tape
10 C frame
12 setting head
14 counter tool
16 engine
20 cutting device
22 cutting part
24 blade
26 projection
28 roller
32 plate
34 rotation axis
36 counter holder
40 actuating part
42 cam
50 guide
120 cutting device
122 cutting part
128 roller
130 teeth
134 rotating axis
140 actuating part
144 tooth rail
S setting stroke

1. A setting tool for setting connecting elements which are provided by a material tape, comprising:
a) a C frame
b) a drive unit arranged at the C frame with a setting head with which the setting head is linearly movable in the direction of a counter tool that is arranged at the C frame opposite the setting head, so that a setting stroke between a setting position for setting the connecting element and a receiving position for receiving a subsequent connecting element from the material tape is defined,
c) an engine for displacing the material tape, with the engine being arranged adjacent to the setting head and being connected to the setting head in a way that it is rigidly arranged relative to the setting head,
d) a cutting device for cutting off the material tape, which is located behind the engine and comprises a cutting part with a blade as well as an actuating part,
e) with the cutting part being connected to the setting head, so that the cutting part is arranged rigidly relative to the setting head, and
f) the actuating part is connected to the setting tool in a way that during operation of the setting tool, there is a relative movement between the actuating part and the cutting part wherein
g) the setting head is movable by the drive unit into a cutting position, which is spaced from the receiving position in a direction opposite to the setting position and in which the blade of the cutting part cuts the material tape due to an actuation by the actuating part transverse to the supply direction of the material tape.

2. The setting tool according to claim 1, furthermore comprising a control with which the cutting position remote from the receiving position is specifically reachable by means of the drive unit.

3. The setting tool according to claim 2, with the control furthermore comprising at least one of:
a) a position detector, with which a position of the setting head for specifically reaching the cutting position is detectable,
b) a counter wherein the cutting position is reachable depending on the counter, or
c) a storage for saving the programming of the setting tool, a counter reading regarding the number of setting processes and/or position data of the setting head.

4. The setting tool according to claim 1, wherein the actuating part comprises a cam and the cutting part comprises a projection so that with a movement of the projection over the cam, the blade is moved in the direction of the material tape and the material tape is cut off.

5. The setting tool according to claim 4, wherein the cutting part comprises a plate with the blade, wherein the plate has a rotation axis at one end and is connected to the projection at the other end so that the material tape is cuttable by means of a pivoting movement of the blade.

6. The setting tool according claim 1, wherein the actuating part comprises a section with tooth rail and the cutting part comprises a roller comprising the blade and is provided with teeth at a partial circumference, so that when the teeth of the roller engage with the tooth rail, the blade is rotated in the direction of the material tape and the material tape is cut off.

7. The setting tool according to claim 1, wherein the actuating part is movable independently of the setting head relative to the direction of movement of the setting head so that an interaction between actuating part and cutting part in the cutting position is avoided.

8. The setting tool according to claim 1, comprising a guide for the cutting part which is comprised of a rail that is fastened to the cutting part as well as a counter rail that is connected to the C frame.

9. A method for setting connecting elements provided with a material tape as well as for cutting off the material tape by using the setting tool according to claim 1, comprising the steps:
a) moving the setting head with a connecting element of the material tape arranged in it from the receiving position to the setting position,
b) setting the connecting element in the setting position,
c) moving back the setting head from the setting position to the receiving position,
d) actuating the engine for displacing the material tape, the engine being located next to the setting head and being connected to the setting head so that it is rigidly arranged relative to the setting head, causing a subsequent connecting element to be arranged in the setting head in the receiving position of the setting head, and
e) moving the setting head with the drive unit to the cutting position which is at a distance to the receiving position in a direction contrary to the setting position, wherein in the cutting position, the cutting device that is arranged in the supply direction of the material tape behind the engine cuts off the material tape transverse to the supply direction of the material tape, wherein the cutting device comprises the cutting part with the blade and the actuating part, wherein the cutting part is connected to the setting head so that the cutting part is rigidly arranged relative to the setting head, and the actuating part is connected to the setting tool in a way that when the setting tool operates, there is a relative movement between the actuating part and the cutting part and in the cutting position, the blade cuts the material tape transverse to the supply direction of the material tape due to an actuation by the actuating part.

10. The setting method according to claim 9, wherein the setting head is moved into the cutting position due to at least one of:
f1) a number of setting strokes between the setting position and the receiving position, wherein the cutting off takes place after two to five setting strokes,
f2) the operating time of the setting tool, or
f3) a manually actuated cutting command.

11. The setting method according to claim 9, comprising the following further step before or at the same time as moving the setting head into the cutting position:
moving the setting tool to a collecting container for cut-off material tape.

12. The setting method according to claim 9, comprising the further step:
moving the actuating part of the cutting device relative to the setting head in a direction relative to the moving direction of the setting head from an engaging position and into a rest position, wherein in the rest position, an interaction between actuating part and cutting part in the cutting position is prevented.
